(19) United States
(12) Patent Application Publication
(10) Pub. No.: US 2013/0328489 A1
(43) Pub. Date: Dec. 12, 2013

(54) REMOTELY DISTRIBUTED POWER NETWORK FOR AN LED LIGHTING SYSTEM

(71) Applicants: RICHARD H. FETTERLY, Jackson, NJ (US); Kevin A. Hebborn, Toms River, NJ (US); Rizwan Ahmad, Summit, NJ (US)

(72) Inventors: RICHARD H. FETTERLY, Jackson, NJ (US); Kevin A. Hebborn, Toms River, NJ (US); Rizwan Ahmad, Summit, NJ (US)

(21) Appl. No.: 13/492,663

(22) Filed: Jun. 8, 2012

(51) Int. Cl. H05B 37/00

(52) U.S. Cl. 315/161; 315/312

(57) ABSTRACT

The present disclosure is directed to a light emitting diode (LED) lighting system. In one embodiment, the LED lighting system includes an LED light source deployed in a first location and a power supply for powering the LED light source, wherein the power supply is remotely located from the LED light source in a second location and designed to power the LED light source to minimize a power loss along a length of an electrical connection coupled between the LED light source and the power supply.

### BACKGROUND

A typical light fixture has a power supply located within the same housing as the light fixture's optics, However, with newer light fixture technologies, the light source may have a longer life span than the power supply. The power supply may need to be replaced several times over the course of the light fixture's life span.

The maintenance required for the light fixture becomes a problem when they are located in hazardous environments or in hard to reach locations such as, for example, towers or high poles. Each time a light fixture must be replaced requires the cost of multiple people and equipment, such as a service lift. In addition, further costs are incurred if production must be halted near the area where the power supply in the light fixture is being replaced.

### SUMMARY

In one embodiment, the present disclosure provides an LED lighting system. In one embodiment, the LED lighting system includes an LED light source deployed in a first location and a power supply for powering the LED light source, wherein the power supply is remotely located from the LED light source in a second location and designed to power the LED light source to minimize a power loss along a length of an electrical connection coupled between the LED light source and the power supply.

In one embodiment, the present disclosure provides another embodiment of an LED lighting system. In one embodiment, the LED lighting system includes a plurality of independently controlled LED light sources deployed in one or more locations and a plurality of power supplies, wherein each one of the plurality of power supplies is for powering one of the plurality of independently controlled LED light sources, wherein the plurality of power supplies are remotely located from the plurality of independently controlled LED light sources in a different location than the one or more locations and designed to power the plurality of independently controlled LED light sources to minimize a power loss along a length of an electrical connection coupled between a respective one of the independently controlled LED light sources and a corresponding one of the plurality of power supplies.

In one embodiment, the present disclosure provides a distributed power network for an LED lighting system. In one embodiment, the distributed power network for an LED lighting system includes a power rack located on a ground level at a first location, one or more power supplies coupled to the power rack via one or more respective electrical connections in the power rack and at least one LED light source located remotely from the power rack in a second location and coupled to the one or more respective electrical connections.

### BRIEF DESCRIPTION OF THE DRAWINGS

So that the manner in which the above recited features of the present disclosure can be understood in detail, a more particular description of the disclosure, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 depicts a high level block diagram of a remotely distributed power network for an LED lighting system.

### DETAILED DESCRIPTION

As discussed above, a typical light fixture has a power supply located within the same housing as the light fixture's optics. However, with newer light emitting diode (LED) light source technologies, the LED light source may have a longer life span than the power supply. The power supply may fail multiple times over the life span of the light fixture before the LED light source fails.

The maintenance required for the light fixture becomes a problem when they are located in hazardous environments or in hard to reach locations such as, for example, towers or high poles. Each time a light fixture must be replaced requires the cost of multiple people and equipment such as a service lift or a scaffolding.

Further costs are incurred if production must be halted near the area where the power supply is being replaced. For example, the area must be shut down such that maintenance personal may work on the light fixture with the failed power supply.

In addition, each time a housing of the light fixture is opened there is a potential for damaging other components within the light fixture. In addition, if the light fixture is in a hazardous or industrial environment, opening the light fixture may also lead to possible exposure of sparks or ignition in the hazardous environment.

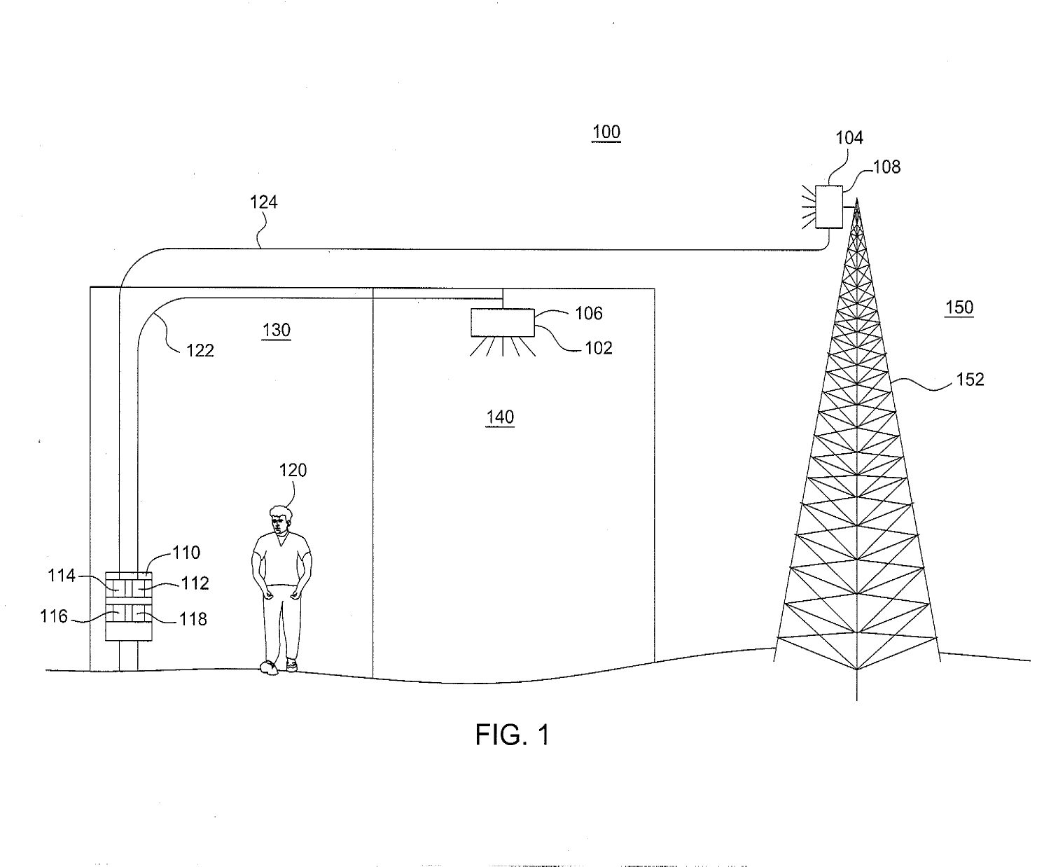

Therefore, in one embodiment of the disclosure, an LED light system is disclosed that has a remotely located power supply. FIG. 1 illustrates a high level block diagram of a remotely distributed power network for an LED lighting system 100. The remotely distributed power network for an LED lighting system 100 may include different locations 130, 140 and 150. Although three different locations are illustrated by example, the remotely distributed power network for an LED lighting system 100 may have any number of different locations.

In one embodiment, one of the locations, for example, location 130 may include a power supply rack 110 that is located on a ground level of the location 130. The power supply rack 110 may include one or more power supplies 112, 114, 116 and 118. Although four power supplies are illustrated in FIG. 1, it should be noted that the power supply rack 110 may be any size to accommodate any number of power supplies as required by an application or deployment of the remotely distributed power network for an LED lighting system 100.

In one embodiment, the one or more power supplies 112, 114, 116 and 118 may each be a plug and play power supply. In other words, the one or more power supplies 112, 114, 116 and 118 may be “hot-swappable” during operation of an LED light source. The one or more power supplies 112, 114, 116 and 118 may each be electrically connected to the power supply rack 110 via any connection suitable for a plug-and-play connection, e.g., a pin connector of any number of pins.

In one embodiment, the power supply rack 110 may be located on a ground level such that a maintenance personnel 120 may easily remove and insert the one or more power supplies 112, 114, 116 and 118 into the power supply rack 110. In other words, to replace a power supply in a light fixture, the maintenance personnel 120 is no longer required to shut down part of the manufacturing floor, use equipment (e.g., a lift), or require multiple maintenance personnel 120. Rather, the maintenance personnel 120 may simply go to the power supply rack 110 on the ground level at location 130 to remove the failed power supply and replace it with a functioning power supply.

In one embodiment, the one or more power supplies 112, 114, 116 and 118 may be electrically connected to one or more LED light sources 102 and 104 located in locations 140 and 150, respectively, via electrical connections 122 and 124, respectively. In one embodiment, the electrical connections 122 and 124 may be made via a electric cable or electric wire. In one embodiment, the location 140 may be an indoor environment such as a manufacturing plant, a warehouse, a mine, and the like. In one embodiment, the location 150 may be an outdoor environment such as a tower or an antennae located outside.

In one embodiment, the LED light sources 102 and 104 may include various electrical components that are not shown, for example, resistors, capacitors, printed circuit boards, optics, reflectors, LED chips or die, and the like. Although FIG. 1 illustrates each location 140 and 150 only having one LED light source 102 and 104, respectively, it should be noted that each location 140 and 150 may have any number of LED light sources.

The one or more power supplies 112, 114, 116 and 118 may provide direct current (DC) to the one or more LED light sources 102 and 104. In one embodiment, the power may be a low voltage DC. For example, the power supply may provide less than 150 Watts (W) of power. The low voltage DC also provides a safer operating environment for the maintenance personnel 120.

In one embodiment, each one of the LED light sources 102 and 104 may be associated with one power supply, e.g., the power supply 112 for the LED light source 102 and the power supply 114 for the LED light source 104. As a result, each one of the LED light sources 102 and 104 may be independently controlled via a respective one of the one or more power supplies 112, 114, 116 and 118. Alternatively, a group of LED light sources may be powered by a single power supply 112, 114, 116 or 118.

Notably, the one or more power supplies 112, 114, 116 and 118 are each located remotely from the LED light sources 102 and 104. In other words, the LED light sources 102 and 104 each have a housing 106 and 108, respectively, that completely encloses an LED die of the LED light sources 102 and 104. The one or more power supplies 112, 114, 116 and 118 are located external to the housing 106 and 108 of the LED light sources 102 and 104. This advantageously allows the power supply to be replaced without having to open the housing 106 and 108. Thus, possible damage to electronics of the LED light sources 102 and 104 inside of the housing 106 and 108, respectively, is minimized.

In one embodiment, the locations 140 and 150 are at different locations than the location 130. Notably, the one or more power supplies 112, 114, 116 and 118 are located at the same location 130 on the ground level. The LED light sources 102 and 104 are located in different remote locations at a level higher than or lower than the ground level. For example, the LED light source 102 may be located above ground on a high warehouse ceiling of location 140 or below ground in a mine that is not easily accessible. The LED light source 104 may be located outdoors on a tower 152 hundreds of feet above ground level.

If a power supply were to be located within the housing 106 and 108 of the LED light sources 102 and 104, respectively, and fail, the maintenance personnel 120 would be required to go out to the location 140 and 150 and use special equipment to replace the power supply. However, using the embodiments of the present disclosure, the maintenance personnel 120 may replace the power supplies (e.g., the power supplies 112 and 114) for the LED light sources 102 and 104 in a single power supply rack 110 at the location 130. In other words, a single maintenance personnel 120 may replace power supplies for two remotely located LED light sources 102 and 104 without having to leave the location 130. As a result, substantial costs savings may be achieved by reducing the number of needed maintenance personnel, costs associated with sending personnel out to locations 140 and 150 and using equipment needed to reach the LED light sources 102 and 104 that are at a level above the ground.

Another advantage of having the one or more power supplies 112, 114, 116 and 118 remotely located from the LED light sources 102 and 104 is that the overall heat load is significantly reduced. In other words, the power supplies 112, 114, 116 and 118 will operate cooler due to being removed away from heat generated by the LED light sources 102 and 104 that directly affects the longevity of the power supplies 112, 114, 116 and 118. As a result, the life span of the LED light sources 102 and 104 is also increased. For example, the life span of the LED light sources 102 and 104 may be increased by 30%-50%.

One possible drawback of having the one or more power supplies 112, 114, 116 and 118 remotely located form the LED light sources 102 and 104 is that there may be a loss of power over a distance of the electrical connections 122 and 124. However, to resolve this issue, the one or more power supplies 112, 114, 116 and 118 may be designed specifically for the LED light sources 102 and 104 such that there is no loss or minimal loss (e.g., less than 10% loss of power) along the distance of the electrical connections 122 and 124. Said another way, the power supplies of the present disclosure are designed to power the LED light sources 102 and 104 at a same voltage as an LED light source having a co-located power supply. For example, the power supply may be designed to be more efficient than a typical off the shelf power supply to ensure that the same voltage is delivered to the LED light sources 102 and 104. A typical off the shelf power supply may have an 80% efficiency, but the power supplies 112, 114, 116 and 118 may have an efficiency of greater than 90%. In addition, the one or more power supplies 112, 114, 116 and 118 are designed to operate at a constant current to further minimize potential voltage drops along the distance of the electrical connections 122 and 124. The design of the one or more power supplies 112, 114, 116 and 118 may be configured to be a function of the distance of the electrical connections 122 and 124 and specific operating parameters of the LED light sources 102 and 104.

In other words, any off-the-shelf power supply cannot be used with the remotely located LED light sources 102 and 104 to maintain a similar voltage requirement as those LED light sources having a power supply inside of the housing. For example, off-the-shelf power supplies may operate at 85% efficiency and require the output voltage to increase from 150 Volts (V) to 200 V to compensate for the power loss along a length of an electrical connection. Thus, the value proposition may be lost due to the significant increase in the voltage requirement needed to drive the LED light source.

As a result, the remotely distributed power network for an LED lighting system 100 provides a more efficient way to operate LED light sources. By improving the ease to which failed power supplies may be replaced, the overall costs associated with maintaining and operating the LED light sources is significantly reduced.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

1. A light emitting diode (LED) lighting system, comprising:
an LED light source deployed in a first location;
a power supply for powering the LED light source, wherein the power supply is remotely located from the LED light source in a second location and designed to power the LED light source to minimize a power loss along a length of an electrical connection coupled between the LED light source and the power supply.

2. The LED lighting system of claim 1, wherein the power supply comprises a plug and play module.

3. The LED lighting system of claim 1, wherein the power supply operates at a constant current.

4. The LED lighting system of claim 1, wherein the power supply comprises a direct current (DC) power source.

5. The LED lighting system of claim 1, comprising a plurality of LED light sources electrically connected to the power supply.

6. The LED lighting system of claim 1, wherein the power supply is external to a housing enclosing the LED light source.

7. The LED lighting system of claim 1, wherein the second location comprises a ground level and the first location comprises a level higher than the ground level.

8. The LED lighting system of claim 1, wherein the second location comprises a ground level and the first location comprises a level lower than the ground level.

9. A light emitting diode (LED) lighting system, comprising:
a plurality of independently controlled LED light sources deployed in one or more locations;
a plurality of power supplies, wherein each one of the plurality of power supplies is for powering one of the plurality of independently controlled LED light sources, wherein the plurality of power supplies is remotely located from the plurality of independently controlled LED light sources in a different location than the one or more locations and designed to power the plurality of independently controlled LED light sources to minimize a power loss along a length of an electrical connection coupled between a respective one of the independently controlled LED light sources and a corresponding one of the plurality of power supplies.

10. The LED lighting system of claim 9, wherein all of the plurality of power supplies are located together in a single power supply rack in the different location.

11. The LED lighting system of claim 10, wherein the different location comprises a ground level and the one or more locations comprises a level higher than the ground level.

12. The LED lighting system of claim 10, wherein the different location comprises a ground level and the one or more locations comprises a level lower than the ground level.

13. The LED lighting system of claim 9, wherein each one of the one or more power supplies is external to a housing of each one of the plurality of independently controlled LED light sources.

14. The LED lighting system of claim 9, wherein each one of the power supplies comprises a plug and play module.

15. The LED lighting system of claim 9, wherein each one of the power supplies comprises a direct current (DC) power source.

16. A distributed power network for a light emitting diode (LED) lighting system, comprising:
a power rack located on a ground level at a first location;
one or more power supplies coupled to the power rack via one or more respective electrical connections in the power rack; and
at least one LED light source located remotely from the power rack in a second location and coupled to the one or more respective electrical connections.

17. The distributed power network for the LED lighting system of claim 16, wherein the second location is located at a level higher than the ground level.

18. The distributed power network for the LED lighting system of claim 16, wherein the second location is located at a level lower than the ground level.

19. The distributed power network for the LED lighting system of claim 16, wherein each one of the one or more respective electrical connections comprises a plug and play connection.

20. The distributed power network for the LED lighting system of claim 17, wherein each one of the one or more power supplies operates at a constant current.
